(19) United States
(12) Patent Application Publication
(10) Pub. No.: US 2015/0295942 A1
(43) Pub. Date: Oct. 15, 2015

(54) METHOD AND SERVER FOR PERFORMING CLOUD DETECTION FOR MALICIOUS INFORMATION

(71) Applicant: Sinan TAO, Shenzhen (CN)

(72) Inventor: Sinan TAO, Shenzhen (CN)

(21) Appl. No.: 14/749,435

(22) Filed: Jun. 24, 2015

Related U.S. Application Data
(63) Continuation of application No. PCT/CN2013/090500, filed on Dec. 26, 2013.

(30) Foreign Application Priority Data
Dec. 26, 2012 (CN) 201210575781.8

(51) Int. Cl. H04L 29/06; G06F 17/22; G06F 17/27; G06F 17/30

(52) U.S. Cl. CPC H04L 63/14; G06F 17/30864; G06F 17/2247; G06F 17/272; G06F 17/2235

(57) ABSTRACT

According to an example, an address of a web page to be identified is obtained, data of the web page from the address of the web page is crawled, the data of the web page is parsed and data for identification is obtained. The web page determined as malicious information according to the data for the identification, and the malicious information is intercepted.

### CROSS-REFERENCE TO RELATED APPLICATIONS

This application is a continuation of International Application No. PCT/CN2013/090500, filed on Dec. 26, 2013, which claims priority to Chinese Patent Application No. 201210575781.8, filed on Dec. 26, 2012, the entire contents of all of which are incorporated herein by reference in their entirety for all purposes.

### FIELD OF THE INVENTION

The present invention relates to communication technologies, more particularly to, a method and server for performing cloud detection for malicious information.

### BACKGROUND OF THE INVENTION

Along with the rapid development of the Internet, data services, especially advertising services have been widely applied to various areas of the Internet. Increasingly, due to the lack of regulation, more malicious information is appears on the Internet, such as malicious advertising.

In conventional methods for processing the malicious information, rule-based technologies are used. Taking the malicious advertising as an example, users need to collect rules, and the rules include websites of the advertising to be intercepted and specific advertising content to be intercepted. Then the collected rules are import into security software and made effective. When the security software recognizes the website of the advertising to be intercepted, the security software automatically filters out the advertising content to be intercepted.

In the conventional methods for processing the malicious information, manual operations are needed. The user needs to collect rules, which is difficult for non-technical users. In addition, the number of the malicious information covered by the rules is small, and response speed of the rules is slow. Further, the malicious information may bypass the interception by replacing links or by using an implants mode.

### SUMMARY OF THE INVENTION

Examples of the present disclosure provide a method and server for performing cloud detection for malicious information, so as to rapidly detect malicious information without manual operations.

A method for performing cloud detection for malicious information includes:

obtaining an address of a web page to be identified;

crawling data of the web page from the address of the web page;

parsing the data of the web page and obtaining data for identification;

determining information in the web page is malicious information according to the data for the identification;

intercepting the malicious information.

A server for performing cloud detection for malicious information includes:

an obtaining unit, to obtain an address of a web page to be identified;

a crawling unit, to crawl data of the web page from the address of the web page;

a parsing unit, to parse the data of the web page and obtaining data for identification;

a determining unit, to determine information in the web page is malicious information according to the data for the identification;

an intercepting unit, to intercept the malicious information.

According to the method and server for performing cloud detection for malicious information provided by the present disclosure, the server obtains the address of the web page to be identified, crawls data of the web page from the address of the web page, parses the data of the web page and obtains data for identification, determines information in the web page is malicious information according to the data for the identification, and intercepts the malicious information. Therefore, the server may analyze the information on the web page and intercept the malicious information without any manual analysis, so that the processing speed of the server is improved.

### BRIEF DESCRIPTION OF THE DRAWINGS

FIG. 1 is a schematic flowchart illustrating a method for performing cloud detection for malicious information according to various examples of the present invention.

FIG. 2 is a schematic flowchart illustrating a method for performing cloud detection for malicious information according to various examples of the present invention.

FIG. 3 is a schematic flowchart illustrating a method for performing cloud detection for malicious information according to various examples of the present invention.

FIG. 4 is a schematic flowchart illustrating a method for performing cloud detection for malicious information according to various examples of the present invention.

FIG. 5 is a schematic diagram illustrating a server according to various examples of the present invention.

### DETAILED DESCRIPTION OF THE INVENTION

The examples of the present application provide the following technical solutions.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The servers and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

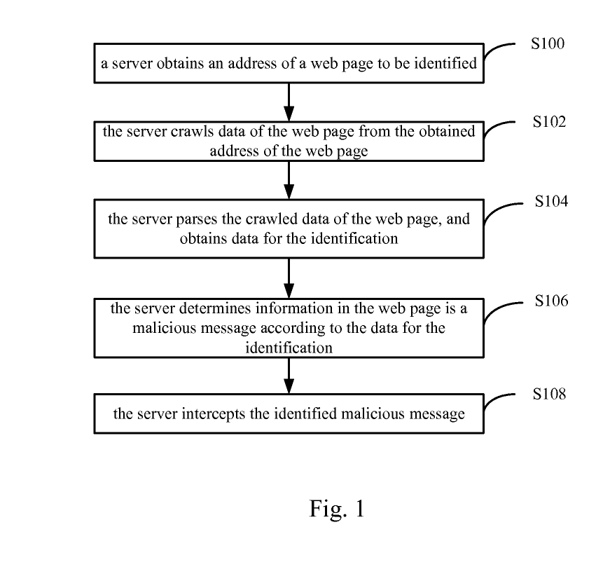

The description will be made as to the various embodiments in conjunction with the accompanying drawings in FIGS. 1-5. It should be understood that specific embodiments described herein are merely intended to explain the present disclosure, but not intended to limit the present disclosure. In accordance with the purposes of this disclosure, as embodied and broadly described herein, this disclosure, in one aspect, relates to method and apparatus for performing cloud detection for malicious information.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

According to examples of the present disclosure, the method for performing cloud detection for malicious information and the server are implemented based on Uniform Resource Locator (URL) cloud killing structure.

In the URL cloud killing structure, after a user enters a URL to be accessed, and before a browser displays page content corresponding to the URL, security software needs to obtain a malicious attribute of the URL to be accessed from a cloud identification center, and prompts the user according to the malicious attributes of the URL. A URL cloud detection engine is used to determine the malicious attributes of the URL. The input of the URL cloud detection engine is a URL, and the output of the URL cloud detection engine is the malicious attributes of the input URL.

According to examples of the present disclosure, the URL cloud detection engine use a web crawler technology, a page parsing technology, a recognition technology of malicious attribute characteristics and behavior. In addition, the URL cloud detection engine also uses a cloud killing technology to improve the response speed and accuracy.

In the web crawler technology, page content corresponding to a URL is obtained first. The URL cloud detection engine uses a web crawler to find the URL and download the page content. In order to crawling web pages of different themes, the web crawlers of different themes may be provided. Further, a certain scoring rules may be configured, so that the URL which is the most threatening has the highest crawling priority.

In the page parsing technology, page content obtained by the web crawler includes HTML tags having certain semantic information. A page content parser may help the URL cloud detection engine to better understand the page content and events, to detect characteristic codes of the page and to extract information needed for identify the malicious attributes.

In the recognition technology of malicious attribute characteristics and behavior, DOM and BOM object content may be identified, and the page content may be identified by performing word segmentation, or by using a Bayesian classifier mode, a similarity mode, a keyword model and etc.

Once the ULR of the malicious information is detected, the URL cloud detection engine reports the ULR of the malicious information to a cloud center immediately, so that the ULR of the malicious information is known and intercepted.

According to the above descriptions, the examples of the present disclosure may rapidly and accurately detect malicious information without manual operations.

The examples of the present disclosure will be illustrated in detail hereinafter with reference to the accompanying drawings and specific examples.

FIG. 1 is a schematic flowchart illustrating a method for performing cloud detection for malicious information according to various examples of the present invention. As shown in FIG. 1, the method includes the following processing.

At S100, a server obtains an address of a web page to be identified. The address of the web page may be a Uniform/Universal Resource Locator (URL).

According to an example, the server may receive URLs from other terminals, and identifies whether each of the URLs is malicious information, or the server may obtain the address of the web page by using other modes.

According to an example, when the server obtains many addresses of the web pages at the same time, the server may divide the obtained addresses of the web pages according to different priorities, and the address of the web page having higher priority is identified earlier.

At S102, the server crawls data of the web page from the obtained address of the web page. The crawled data of the web page includes at least one of a Hypertext Markup Language (HTML) file, a Client-Side Scripting Language (CSSL) file, a Document Object Model (DOM) file, and a Cascading Style Sheets (CSS) file.

The HTML file is a main body of a web document, and stored as a text file, and colorful pages may be displayed after the HTML file is translated by a browser. The CSSL mainly includes Javascript (JS), VBSscript (VBS), Jscript. DOM obtains objects based on content of the web page. Each object has its own Properties, Method and Events, and these may be controlled by the CSSL. The CSS is one of markup languages that used to control the style of the web page and allow the separating of style information and content of the web page. The CSS is to offset inadequate caused by limitations of the HTML in the layout. The CSS is part of the DOM, and CSS properties may be changed dynamically through the CSSL, thereby changing page visual effects.

According to an example, starting from a URL of one or multiple initial pages, the server obtains the URL of the initial page. In the procedure of crawling the web page, the server continuously extracts a new URL from the current page and puts the new URL into a queue, until a stop condition is satisfied. The stop condition may be that all of the URLs are crawled or a certain number of URLs are crawled, e.g. 1000 URLs are crawled. All of the crawled pages are stored by a system and may be analyzed or filtered, and an index may be configured for subsequent search and retrieval.

At S104, the server parses the crawled data of the web page, and obtains data for the identification.

The server extracts data needed by malicious information detection engine from page content composed by HTML tags. According to an example, the extracted data may be at least one of executed JS, a page title, goods information, a DOM tree or a BOM tree corresponding to the web page, and a hyperlink corresponding to the web page.

At S106, the server determines information in the web page is malicious information according to the data for the identification.

According to the obtained data for the identification, the server may use machine recognition technologies, e.g. word segmentation, text similarity matching, keyword filtering and etc. According to an example, the server may dynamically executes JS script of the web page by V8, and extract a message link in a script file of a DOM tree for changing a page, and then determine whether the information in the web page is the malicious information. According to an example, for dealing with information hiding technologies, in which a whole message page is a picture, the server may use technologies, e.g. message page snapshot, picture similarity matching, picture identification, so as to prevent the malicious information from bypassing the detection of the malicious information detection engine.

According to an example, the server takes a hyperlink of a message as an input, obtains page content corresponding to the hyperlink of the message by using a webkit core, and generates a message effect picture corresponding to the page content by performing page rendering. The server performs machine identification for the message effect picture corresponding to the page content, extracts text or an object in the message effect picture, compares the extracted text or object with content in a malicious information picture database, and identifies the page by using an identification method of machine learning, e.g. by using keyword filtering. The server outputs information indicating whether the page is malicious information page.

According to an example, the server may perform similarity matching for a page picture finally displayed on the browser and seed page pictures of malicious information collected by the malicious information detection engine, and directly determine the page picture is the malicious information when a similarity reaches a preconfigured value.

According to an example, the server may perform word segmentation for page text content and obtain semantic information of the page text content.

According to an example, the server may perform similarity matching for the parsed page text content and collected text content of malicious information, and outputs a matching result.

According to an example, the server may determine whether the page is the malicious information according to the parsed page text content of the message page, by using an identification method of machine learning, e.g. Bayesian classifier, keyword model, a decision tree and etc.

At S108, the server intercepts the identified malicious information.

According to the examples of the present disclosure, the server obtains the address of the web page to be identified, crawls data of the web page from the address of the web page, parses the data of the web page and obtains data for identification, determines information in the web page is malicious information according to the data for the identification, and intercepts the malicious information. Therefore, the server may analyze the information on the web page and intercept the malicious information without any manual analysis, so that the processing speed of the server is improved.

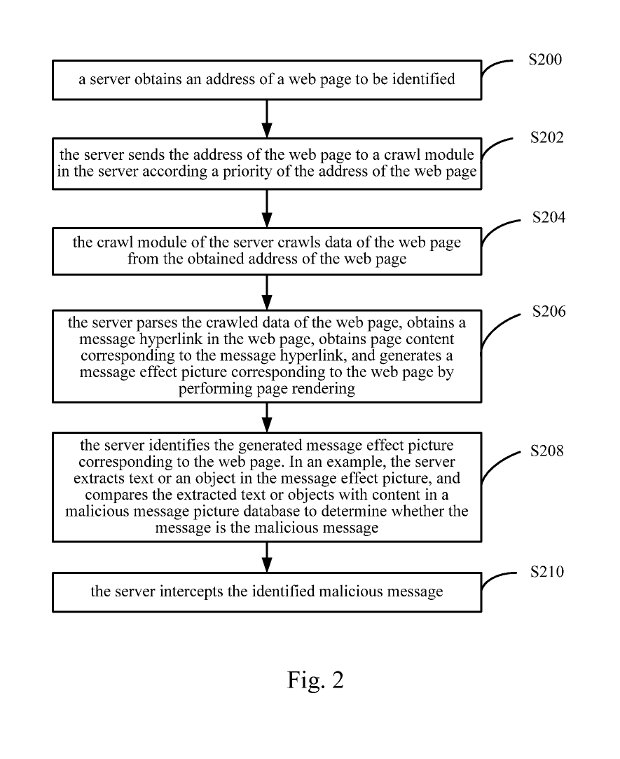

FIG. 2 is a schematic flowchart illustrating a method for performing cloud detection for malicious information according to various examples of the present invention. In the method, a message in an URL is identified. As shown in FIG. 2, the method includes the following processing.

At S200, a server obtains an address of a web page to be identified. The address of the web page to be identified may be a URL.

At S202, the server sends the address of the web page to a crawl module in the server according a priority of the address of the web page. The server may include multiple crawl modules, and each crawl module may obtain the data of the web page separately.

At S204, the crawl module of the server crawls data of the web page from the obtained address of the web page. The crawled data of the web page includes at least one of a HTML file, a CSSL file, a DOM file, and a CSS file.

At S206, the server parses the crawled data of the web page, and obtains a message hyperlink in the web page, obtains page content corresponding to the message hyperlink, and generates a message effect picture corresponding to the web page by performing page rendering.

At S208, the server identifies the generated message effect picture corresponding to the web page.

According to an example, the server extracts text or an object in the message effect picture, and compares the extracted text or objects with content in a malicious information picture database to determine whether the message is the malicious information. According to an example, the server may identify the page by using an identification method of machine learning, e.g. by using keywords. For example, by using Bayesian classification, a keyword model, a tree identification method, the server determines whether the web page is malicious information page according to the text or object, and outputs information indicating whether the page is malicious information page.

At S210, the server intercepts the identified malicious information.

According to the examples of the present disclosure, the server obtains the address of the web page to be identified, crawls data of the web page from the address of the web page, parses the data of the web page and obtains data for identification, determines information in the web page is malicious information according to the data for the identification, and intercepts the malicious information. Therefore, the server may analyze the message on the web page and intercept the malicious information without any manual analysis, so that the processing speed of the server is improved.

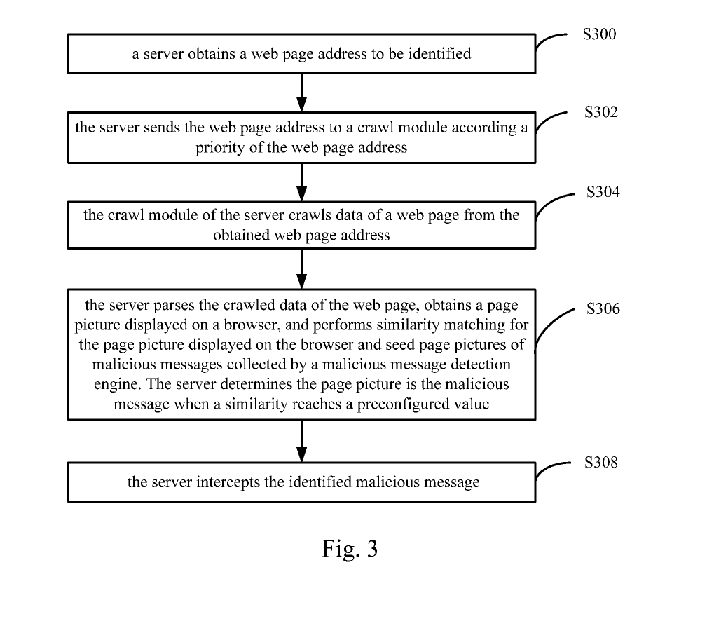

FIG. 3 is a schematic flowchart illustrating a method for performing cloud detection for malicious information according to various examples of the present invention. As shown in FIG. 3, the method includes the following processing.

At S300, a server obtains a web page address to be identified. The web page address may be a URL.

At S302, the server sends the web page address to a crawl module according a priority of the web page address. The server may include multiple crawl modules, and each crawl module may obtain data of a web page separately.

At S304, the crawl module of the server crawls data of a web page from the obtained web page address. The crawled data of the web page include at least one of a HTML file, a CSSL file, a DOM file, and a CSS file.

At S306, the server parses the crawled data of the web page, obtains a page picture displayed on a browser, and performs similarity matching for the page picture displayed on the browser and seed page pictures of malicious information collected by malicious information detection engine. The server directly determines the page picture is the malicious information when a similarity reaches a preconfigured value.

At S308, the server intercepts the identified malicious information.

According to the examples of the present disclosure, the server obtains the address of the web page to be identified, crawls data of the web page from the address of the web page, parses the data of the web page and obtains data for identification, determines information in the web page is malicious information according to the data for the identification, and intercepts the malicious information. Therefore, the server may analyze the information on the web page and intercept the malicious information without any manual analysis, so that the processing speed of the server is improved.

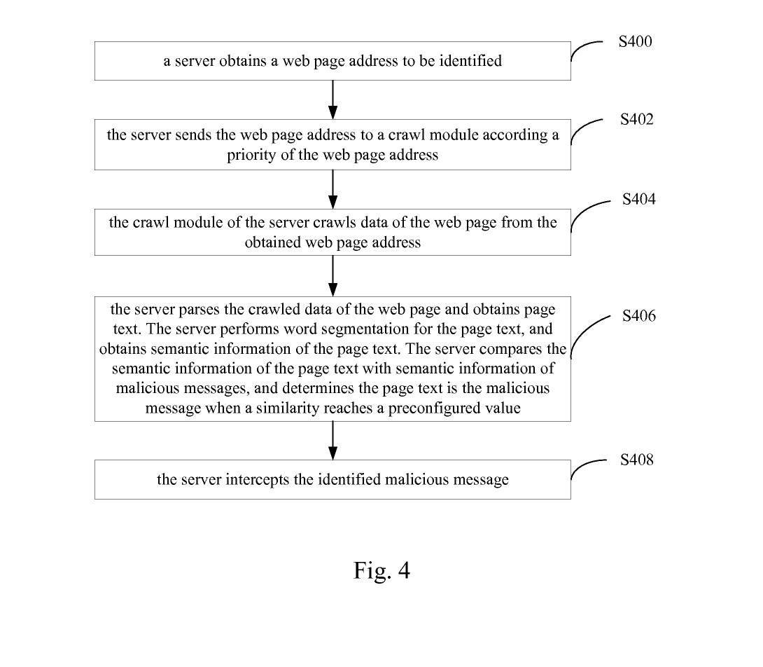

FIG. 4 is a schematic flowchart illustrating a method for performing cloud detection for malicious information according to various examples of the present invention. As shown in FIG. 4, the method includes the following processing.

At S400, a server obtains a web page address to be identified. The web page address may be a URL.

At S402, the server sends the web page address to a crawl module according a priority of the web page address. The server may include multiple crawl modules, and each crawl module may obtain data of a web page separately.

At S404, the crawl module of the server crawls data of the web page from the obtained web page address. The crawled data of the web page include at least one of a HTML file, a CSSL file, a DOM file, and a CSS file.

At S406, the server parses the crawled data of the web page and obtains page text. The server performs word segmentation for the page text, and obtains semantic information of the page text. The server compares the semantic information of the page text with semantic information of malicious information, and determines the page text is the malicious information when a similarity reaches a preconfigured value.

According to an example, as an alternative solution of the processing at S406, i.e. S406a, the server may parse the data of the web page and obtain page text. Then the server performs similarity matching for the parsed page text and collected text content of malicious information, and outputs a matching result.

According to an example, as another alternative solution of the processing at S406, i.e. S406b, the server may parse the data of the web page, and obtains text content of the message page, determine whether the text content is the malicious information, by using an identification method of machine learning, e.g. Bayesian classifier mode, a keyword model, a decision tree and etc.

At S408, the server intercepts the identified malicious information.

According to the examples of the present disclosure, the server obtains the address of the web page to be identified, crawls data of the web page from the address of the web page, parses the data of the web page and obtains data for identification, determines information in the web page is malicious information according to the data for the identification, and intercepts the malicious information. Therefore, the server may analyze the information on the web page and intercept the malicious information without any manual analysis, so that the processing speed of the server is improved.

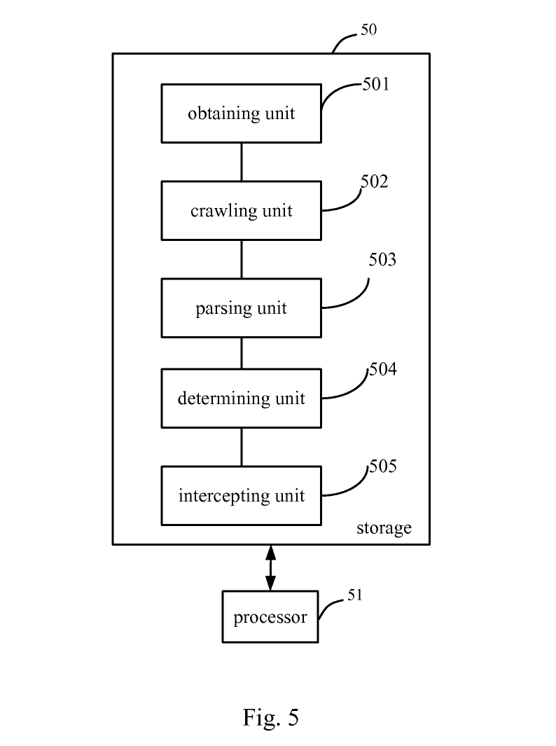

FIG. 5 is a schematic diagram illustrating a server according to various examples of the present invention. As shown in FIG. 5, the server includes storage 50 and a processor 51. According to an example, the storage 50 may be non-transitory computer readable storage medium. The storage 50 stores computer readable instructions for implementing an obtaining unit 501, a crawling unit 502, a parsing unit 503, a determining unit 504 and an intercepting unit 505. The processor 51 may execute the computer readable instructions stored in the storage 50.

The obtaining unit 501 is to obtain an address of a web page to be identified.

The address of the web page may be a URL. According to an example, the server may receive URLs from other terminals, and identifies whether each of the URLs is malicious information, or the server may obtain the address of the web page by using other modes.

According to an example, when the server obtains many addresses of the web pages at the same time, the server may divide the obtained addresses of the web pages according to different priorities, and the address of the web page having higher priority is identified earlier.

The crawling unit 502 is to crawl data of the web page from the address of the web page. The crawled data of the web page includes at least one of a HTML file, a CSSL file, a DOM file, and a CSS file.

According to an example, starting from a URL of one or multiple initial pages, the server obtains the URL of the initial page. In the procedure of crawling the web page, the server continuously extracts a new URL from the current page and puts the new URL into a queue, until a stop condition is satisfied. The stop condition may be that all of the URLs are crawled or a certain number of URLs are crawled, e.g. 1000 URLs are crawled. All of the crawled pages are stored by a system and may be analyzed or filtered, and an index may be configured for subsequent search and retrieval.

The parsing unit 503 is to parse the data of the web page and obtaining data for identification.

The server extracts data needed by malicious information detection engine from page content composed by HTML tags. According to an example, the extracted data may be at least one of executed JS, a page title, goods information, a DOM tree or a BOM tree, and a hyperlink for parsing jumping of a web message.

The determining unit 504 is to determine information in the web page is malicious information according to the data for the identification.

According to the obtained data for the identification, the determining unit 504 may use machine recognition technologies, e.g. word segmentation, text similarity matching, keyword filtering and etc. According to an example, the server may dynamically executes JS script of the web page by V8, and extract a message link in a script file of a DOM tree for changing a page, and then determine whether the information in the web page is the malicious information. According to an example, for dealing with information hiding technologies, in which a whole message page is a picture, the server may use technologies, e.g. message page snapshot, picture similarity matching, picture identification, so as to prevent the malicious information from bypassing the detection of the malicious information detection engine.

According to an example, the determining unit 504 takes a hyperlink of a message as an input, obtains page content corresponding to the hyperlink of the message by using a webkit core, and generates a message effect picture corresponding to the page content by performing page rendering. The server performs machine identification for the message effect picture corresponding to the page content, extracts text or an object in the message effect picture, compares the extracted text or object with content in a malicious information picture database, and identifies the page by using an identification method of machine learning, e.g. by using keyword filtering. The server outputs information indicating whether the page is malicious information page.

According to an example, the determining unit 504 may perform similarity matching for a page picture finally displayed on the browser and seed page pictures of malicious information collected by the malicious information detection engine, and directly determine the page picture is the malicious information when a similarity reaches a preconfigured value.

According to an example, the determining unit 504 may perform word segmentation for page text content and obtain semantic information of the page text content.

According to an example, the determining unit 504 may perform similarity matching for the parsed page text content and collected text content of malicious information, and outputs a matching result.

According to an example, the determining unit 504 may determine whether the page is the malicious information according to the parsed page text content of the message page, by using an identification method of machine learning, e.g. Bayesian classifier, keyword model, a decision tree and etc.

The intercepting unit 505 is to intercept the malicious information.

According to the examples of the present disclosure, the server obtains the address of the web page to be identified, crawls data of the web page from the address of the web page, parses the data of the web page and obtains data for identification, determines information in the web page is malicious information according to the data for the identification, and intercepts the malicious information. Therefore, the server may analyze the information on the web page and intercept the malicious information without any manual analysis, so that the processing speed of the server is improved.

According to an example, the data of the web page crawled by the crawling unit comprises at least one of a HTML file, a CSSL file, a DOM file, and a CSS file.

According to an example, the parsing unit 503 is to parse the data of the web page, obtain a hyperlink of a message, obtain page content corresponding to the hyperlink of the message, and generate a message effect picture corresponding to the page content by performing page rendering.

The determining unit 504 is to extract text or an object in the message effect picture, compare the text or the object with content in a malicious information picture database, and determine the message is the malicious information according to a comparing result.

According to an example, the parsing unit 503 is to parse the data of the web page, and obtain a page picture displayed on a browser.

The determining unit 504 is to perform similarity matching for the page picture displayed on the browser and seed page pictures of malicious information, and determine the page picture is the malicious information when a similarity reaches a preconfigured value.

According to an example, the parsing unit 503 is to parse the data of the web page, obtain page text, perform word segmentation for the page text, and obtain semantic information of the page text.

The determining unit 504 is to compare the semantic information of the page text with semantic information of malicious information, and determine the page text is the malicious information when a similarity reaches a preconfigured value.

According to an example, the parsing unit 503 is to parse the data of the web page; and obtain page text.

The determining unit 504 is to perform similarity matching for the page text and text content of malicious information, and determine the page text is the malicious information when a similarity reaches a preconfigured value.

According to an example, the parsing unit 503 is to parse the data of the web page and obtain page text.

The determining unit 504 is to determine the page text is the malicious information by using a Bayesian classifier mode, a keyword model, or a decision tree.

The methods and modules described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in storage in an extension board inserted in the computer or in storage in an extension unit connected to the computer. In this example, a CPU in the extension board or the extension unit executes at least part of the operations according to the instructions based on the program codes to realize a technical scheme of any of the above examples.

The foregoing is only preferred examples of the present invention and is not used to limit the protection scope of the present invention. Any modification, equivalent substitution and improvement without departing from the spirit and principle of the present invention are within the protection scope of the present invention.

1. A method for performing cloud detection for malicious information, comprising:
obtaining an address of a web page to be identified;
crawling data of the web page from the address of the web page;
parsing the data of the web page and obtaining data for identification;
determining information in the web page is malicious information according to the data for the identification;
intercepting the malicious information.

2. The method of claim 1, wherein the data of the web page crawled from the address of the web page comprises at least one of a Hypertext Markup Language (HTML) file, a Client-Side Scripting Language (CSSL) file, a Document Object Model (DOM) file, and a Cascading Style Sheets (CSS) file.

3. The method of claim 1,
wherein parsing the data of the web page and obtaining the data for identification comprises:
parsing the data of the web page;
obtaining a hyperlink of a message;
obtaining page content corresponding to the hyperlink of the message; and
generating a message effect picture corresponding to the web page by performing page rendering;
wherein determining the information in the web page is the malicious information according to the data for the identification comprises:
identifying the message effect picture corresponding to the web page;
extracting text or an object in the message effect picture;
comparing the text or the object with content in a malicious information picture database; and
determining the message is the malicious information according to a comparing result.

4. The method of claim 3, wherein comparing the text or the object with content in the malicious information picture database comprises:
comparing the text or the object with content in the malicious information picture database by using a Bayesian classifier mode, a keyword model, or a decision tree.

5. The method of claim 1,
wherein parsing the data of the web page and obtaining data for identification comprises:
parsing the data of the web page; and obtaining a page picture displayed on a browser;
wherein determining the information in the web page is the malicious information according to the data for the identification comprises:
performing similarity matching for the page picture displayed on the browser and seed page pictures of malicious information;
determining the page picture is the malicious information when a similarity reaches a preconfigured value.

6. The method of claim 1,
wherein parsing the data of the web page and obtaining the data for identification comprises:
parsing the data of the web page;
obtaining page text;
performing word segmentation for the page text;
obtaining semantic information of the page text;
wherein determining the information in the web page is the malicious information according to the data for the identification comprises:
comparing the semantic information of the page text with semantic information of malicious information;
determining the page text is the malicious information when a similarity reaches a preconfigured value.

7. The method of claim 1,
wherein parsing the data of the web page and obtaining data for identification comprises:
parsing the data of the web page; and obtaining page text;
wherein determining the information in the web page is the malicious information according to the data for the identification comprises:
performing similarity matching for the page text and text content of malicious information;
determining the page text is the malicious information when a similarity reaches a preconfigured value.

8. The method of claim 1, wherein
wherein parsing the data of the web page and obtaining the data for identification comprises:
parsing the data of the web page; and obtaining page text;
wherein determining the information in the web page is the malicious information according to the data for the identification comprises:
determining the page text is the malicious information by using a Bayesian classifier mode, a keyword model, or a decision tree.

9. A server, comprising:
an obtaining unit, to obtain an address of a web page to be identified;
a crawling unit, to crawl data of the web page from the address of the web page;
a parsing unit, to parse the data of the web page and obtaining data for identification;
a determining unit, to determine information in the web page is malicious information according to the data for the identification;
an intercepting unit, to intercept the malicious information.

10. The server of claim 9, wherein the data of the web page crawled by the crawling unit comprises at least one of a Hypertext Markup Language (HTML) file, a Client-Side Scripting Language (CSSL) file, a Document Object Model (DOM) file, and a Cascading Style Sheets (CSS) file.

11. The server of claim 9, wherein
the parsing unit is to parse the data of the web page; obtain a hyperlink of a message;
obtain page content corresponding to the hyperlink of the message; and generate a message effect picture corresponding to the web page by performing page rendering;
the determining unit is to extract text or an object in the message effect picture; compare the text or the object with content in a malicious information picture database; and determine the message is the malicious information according to a comparing result.

12. The server of claim 9, wherein
the parsing unit is to parse the data of the web page; and obtain a page picture displayed on a browser;
the determining unit is to perform similarity matching for the page picture displayed on the browser and seed page pictures of malicious information; and determine the page picture is the malicious information when a similarity reaches a preconfigured value.

13. The server of claim 9, wherein
the parsing unit is to parse the data of the web page; obtain page text; perform word segmentation for the page text; and obtain semantic information of the page text;
the determining unit is to compare the semantic information of the page text with semantic information of malicious information; and determine the page text is the malicious information when a similarity reaches a preconfigured value.

14. The server of claim 9, wherein
the parsing unit is to parse the data of the web page; and obtain page text;
the determining unit is to perform similarity matching for the page text and text content of malicious information; and determine the page text is the malicious information when a similarity reaches a preconfigured value.

15. The server of claim 9, wherein
the parsing unit is to parse the data of the web page; and obtain page text;
the determining unit is to determine the page text is the malicious information by using a Bayesian classifier mode, a keyword model, or a decision tree.
